(19) United States
(12) Patent Application Publication
(10) Pub. No.: US 2010/0266811 A1
(43) Pub. Date: Oct. 21, 2010

(54) Shingle With Sharply Defined Tabs Separated by Slots and Method of Making

(75) Inventors: Husnu M. Kalkanoglu, Swarthmore, PA (US); Robert L. Jenkins, Honey Brook, PA (US)

Correspondence Address: PAUL AND PAUL, 2000 MARKET STREET, SUITE 2900, PHILADELPHIA, PA, 19103, US

(73) Assignee: CERTAINTEED CORPORATION, Valley Forge, PA (US)

(21) Appl. No.: 12/823,552

(22) Filed: Jun. 25, 2010

Related U.S. Application Data
(63) Continuation of application No. 10/807,018, filed on Mar. 23, 2004, now abandoned.

(51) Int. Cl. E04D 1/26; E04D 1/00; B05D 7/24

(52) U.S. Cl. 428/143; 427/187; 427/188

(57) ABSTRACT

A shingle is provided and its method of manufacture, in which granules are applied to an upper surface of a hardenable coating on a layer of shingle-making material, with granules of different pre-selected visual aesthetics provided in different tab areas, separated by mixtures of granules from adjacent tab areas forming intermediate areas, and in which the intermediate areas are removed to yield slots separating adjacent tabs, leaving visually sharp, precise starting and ending delineations for the tabs of a given aesthetic, that can be the same as or different than the aesthetic of an adjacent tab.

### CROSS-REFERENCE TO RELATED APPLICATION

This is a continuation of application Ser. No. 10/807,018, filed Mar. 23, 2004.

### BACKGROUND OF THE INVENTION

Shingles of the type having a butt portion and a tab portion, with slots separating tabs of the tab portion of the shingle, are known in the art. U.S. Pat. Nos. 6,212,843 and 6,467,235 represent examples of such shingles and their method of manufacture.

It is also known to manufacture shingles, either of the single layer type or of the laminated type, comprising two or more layers of complete shingle material, wherein each layer of complete shingle material includes a base web of reinforcing material that is impregnated with and coated with an adhesive material, generally asphalt, which hardens, and with granules applied to an upper surface of the shingle material.

Generally, the shingles are made by having a base web, often of fiberglass construction, as a reinforcing material, impregnated with the bitumen or other adhesive material, as part of a continuous process, and in which the granules are dropped onto the continuous sheet of impregnated and coated material, to adhere thereto, with the granules being dropped from granule applicators. Often, there are a plurality of granule applicators, which apply granules of a certain preselected aesthetic onto different portions of the shingle-forming layer passing therebeneath. For example, the granule applicators may contain granules of different colors, different shadings of the same color, different blends of color or shading, etc.

It is desirable to have adjacent tabs separated by slots, wherein the tabs have some form of contrast or aesthetic from tab-to-tab. The contrast may be in the form of different shades of the same color, different colors from tab-to-tab, different blends of colors or shading from tab-to-tab, or of other variations.

Often, the goal of such manners of shingle manufacture is to provide shingles that, once they are laid up on a roof, give the appearance of individual tiles, or individual slates, as may be desired, rather than appearing as tabs of a manufactured shingle.

Because control of the dropping of granules from a given applicator may not be absolutely or precisely perfect, where shingles from a given hopper-type applicator may be intended to be dropped in a preplanned tab area of a shingle-forming layer passing therebeneath, and wherein granules from a different hopper applicator may be intended to be dropped on an adjacent tab area, there is often an intermediate zone or area, between adjacent tab areas, where there is a blend of granules from one applicator with granules from another applicator.

### SUMMARY OF INVENTION

The present invention is directed to providing a shingle and a method of making a shingle in which adjacent tabs can be sharply defined, in which granules of a given aesthetic are applied to one tab area and granules of another aesthetic are applied to an adjacent tab area, and which any mixture of granules from both of those areas that are applied to an intermediate area between those two tab areas, are removed by removing the entire intermediate area, to yield two distinct tabs.

Accordingly, it is an object of the present invention to provide a shingle and a method of making the shingle, in which granules of more than one aesthetic are applied to a shingle-forming layer, each in a different area, and wherein a mixture of granules of both aesthetics are applied in an intermediate area, which intermediate area is then removed to yield adjacent shingle tabs that are sharply defined, each having granules only of its own predetermined aesthetic.

It is another object to accomplish the above objects, wherein the removal takes place by cutting generally transverse slots between tab areas such that each remaining tab area yields visually sharp, precise starting and ending delineations of its own aesthetic.

Other objects and advantages of the present invention will be readily apparent upon the reading of the following brief description of the drawing figures, the detailed descriptions of the preferred embodiments, and the appended claims.

### BRIEF DESCRIPTION OF THE DRAWING FIGURES

FIG. 1 is a side elevational view of a layer of shingle-forming material being continuously conveyed along a generally horizontal path, beneath a plurality of hopper type granule applicators which are dropping granules onto predetermined tab areas of the coated web of shingle-forming material.

FIG. 2 is a top view of the continuous coated web of shingle-forming material, with granules of different aesthetics already applied thereto, in different areas, spaced by intervening transitional or intermediate areas, which intermediate areas contain mixtures or blends of granules from each adjacent tab area.

FIG. 3 illustrates the continuous layer of shingle-forming material, with granules already applied thereon, passing under slot-forming cutting apparatus and shingle separation cutting apparatus.

FIG. 3A is a fragmentary illustration similar to that of FIG. 3, but wherein a rotary mechanism is illustrated for cutting the slots between adjacent tabs and cutting the shingle-forming material into individual shingles.

FIG. 4 is an illustration similar to that of FIG. 2, but after the slots have been cut between adjacent tabs of the shingle, removing the intermediate areas that had contained mixtures or blends of granules from the adjacent tab areas.

FIG. 5 is a top view of a completed shingle made in accordance with this invention.

FIG. 6 is a front edge view of a completed shingle in accordance with this invention, having multi-layers, to yield a laminated shingle.

### DETAILED DESCRIPTIONS OF THE PREFERRED EMBODIMENTS

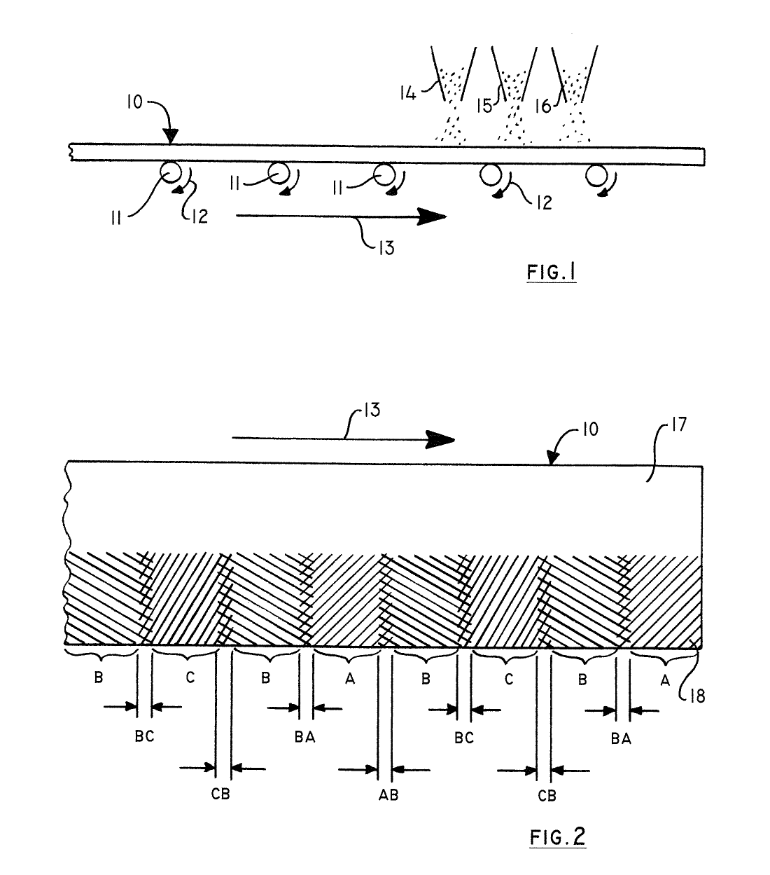

Referring to the drawings in detail, reference is first made to FIG. 1, wherein a continuous layer of shingle-forming material is illustrated by the numeral 10, as comprising a base web of reinforcing material, generally of fiberglass construction, impregnated with and coated with an adhesive material, generally of the asphalt or other bitumen type, as a hardenable coating, to an upper and lower surface thereof. Such layer of shingle-forming material, up to this point in the manufacture, may be constructed as disclosed in either of the above-mentioned U.S. Pat. Nos. 6,212,843 or 6,467,235, or by other techniques.

The shingle-forming material 10 is horizontally conveyed along a conveyor formed by a plurality of rollers 11, being rotated in the clockwise direction shown by the arrows 12, such that the shingle-forming material is moved from left to right as shown in FIG. 1, in the direction of the arrow 13, to pass beneath a plurality of hopper-type granule applicators 14, 15 and 16.

It will be apparent that any number of granule applicators may be used as may be desired, depending upon the aesthetic illustration desired in the final shingle.

For purposes of this application, the granules being dispensed from each of the applicators 14, 15 and/or 16 will be referred to as granules of a given “aesthetic”. It will be understood that as used herein “aesthetic” can mean that the granules dispensed from the various applicators may be granules of a different color or appearance, or may be granules of different shades of the same color, or components of either of them. Similarly, they can be granules of different sizes or shapes, textures, or a given granule applicator may contain a blend of granules of predetermined colors and/or shadings, and that the other granule applicators may contain granules of a different blend of colors, shadings, sizes, etc. Granules of different materials and compositions may be used, such as, for example, including but not limited to, natural rock, slag, ceramic coated rock or mineral particles, or granules of various mineral content.

Thus, as used herein, the term “aesthetic”, will mean a given, predetermined array of granules that will yield a certain visual impression, which will often be different than an array of granules that yields a different visual impression from that of an adjacent tab area. Alternatively, some adjacent tab areas could have the same aesthetics, to give the same visual impression, if desired.

Accordingly, with reference to FIG. 2, it will be seen that the layer of shingle-forming material is provided with an upper butt portion 17 and a lower tab portion 18.

The butt portion 17 will generally be provided with granules that are adapted to be covered when shingles are laid-up on a roof, and such granules can be as are disclosed in U.S. Pat. Nos. 6,212,843 or 6,467,235, or of any other type, in that such are not the granules to which the present invention is directed. The granules that are applied from the applicators 14, 15 and 16 of FIG. 1, are granules that will produce “aesthetics” A, B, and C as shown in FIG. 2.

Because the deposit of granules from the applicators 14, 15 and 16 can be stopped or started by various techniques, well known in the art, such as openable doors (not shown), the aesthetic areas A, B, and C will not necessarily always follow each other, in that various aesthetic areas can be controlled by conventional granule drop techniques, such that a B area can follow a C area, an A area can follow B area, etc, as shown in FIG. 2, or any other variations of different aesthetic areas following a previous aesthetic area. The arrangement of the variations of different aesthetic areas can be patterned or have a random distribution.

In any event, between the various A, B and C aesthetic areas, it will be seen that there are intermediate areas in the tab portion 18, such as, as viewed from right-to-left as viewed in FIG. 2, the intermediate area BA between areas A and B, the intermediate area CB between areas B and C, the intermediate area BC between areas C and B, the intermediate area AB between areas B and A, the intermediate area BA between areas A and B, the intermediate area CB between areas B and C, and the intermediate area BC between areas C and B, for example.

For ease of understanding, in the course of this application, the tab areas A, B and C will be considered “primary” areas, and the areas BA, CB, BC, AB, BA, CB and BC will be considered intermediate or transitional areas.

It will also be understood that the intermediate or transitional areas are comprised, in each case, of some blend or mixture of granules from each of the primary areas on each side of the transitional area, and that such occurs because of the limitations on precision with regard to the dropping of granules; that is, that it is not always possible to precisely stop the application of granules, or to precisely start the application of granules when they are being delivered via gravity drop from a hopper-type granule applicator, roll- or belt-type granule applicator, or any other type of applicator. Application may also be provided with pneumatic assist, contact adhesion, or particle placement devices.

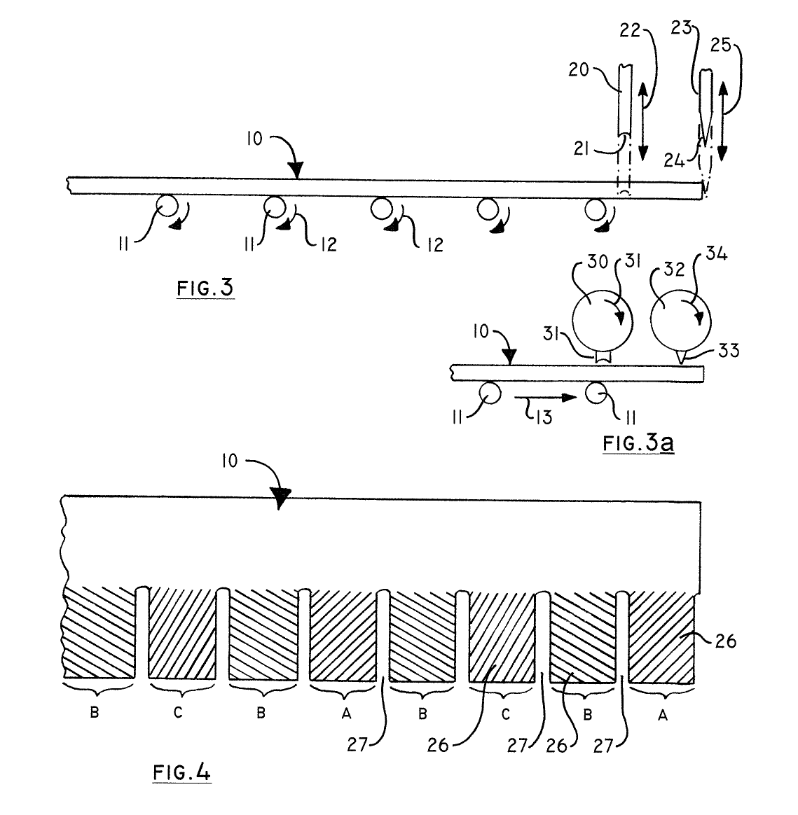

With reference now to FIG. 3, it will be seen that the continuous sheet of shingle-forming material 10, after application of granules, continues on over rollers 11 or other types of conveying apparatus, to a slot forming device 20. The slot forming device 20 may be of any desired type, but could be of the type illustrated in FIG. 3, in which the device 20 is moved upwardly or downwardly, so that its slot-cutting portion 21, when moved downwardly in the direction of the double headed arrow 22, can cut out the intermediate areas of the tab portion between primary areas of the tab portion, to yield spaced-apart tabs 26, separated by slots 27. While FIG. 4 shows each of the tabs 26 to have similar parameters of shape, length, and width, with respect to one another, these parameters could be varied from tab to tab. Similarly, the width of slots 27 may vary from slot to slot. Thus, in an alternative embodiment, the shingle-forming layer 10 can be made with at least one of the parameters of tab shape, tab length, tab width and slot width varied as the sheet is conveyed through the manufacturing process.

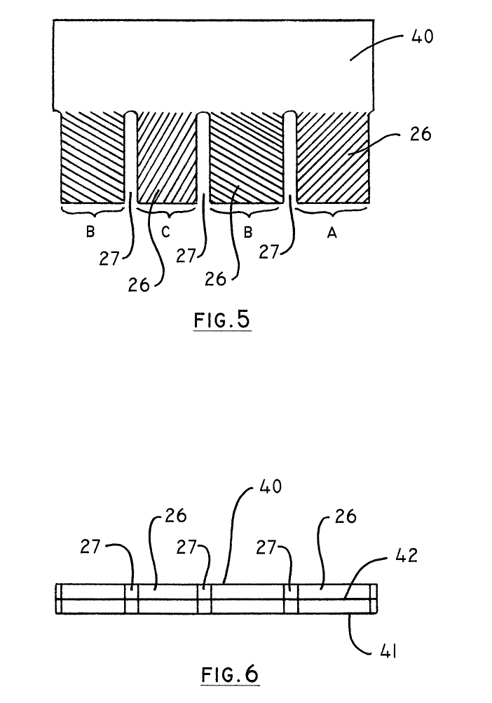

The shingle-forming layer 10 is then delivered to a cutter mechanism 23, which also can be of the type that moves vertically upwardly and downwardly in the direction of the double headed arrow 25, such that its lower edge 24 can cut through the shingle-forming material 10 when desired, to separate the shingle-forming material 10 into separate discrete shingles, each comprising a plurality of tabs, such as the four-tab shingle of FIG. 5.

With reference now to FIG. 3A, it will be seen that the shingle-forming layer 10 may have its slots and shingle cut-off formed therein by means of a rotary member 30 having a slot cutter 31 carried thereby, which cuts the slots 27 in the shingle-forming material 10 as the rotary cutter is turned in the direction of the arrow 31. Similarly, the shingle cut-off mechanism may, in lieu of that shown in FIG. 3, be comprised of a rotary member 32 having a cutting blade 33 thereon, which cuts the shingle-forming material 10 into separate discrete shingles, as the cutter mechanism 32 is rotated in the direction of the arrow 34. Other cutting or removal means known in the art may be employed to form the slots or to cut the shingle-forming material into separate discrete shingles.

Referring now to FIG. 5, it will be seen that a representative shingle is shown, having a plurality of aesthetic areas that sharply define the tabs 26, separated by slots 27, with each slot being as wide in the longitudinal direction from left-to-right as shown, as at least the width of the entire intermediate area between adjacent primary areas as shown in FIG. 2, such that in each case the entire intermediate area is removed, leaving visually sharp, precise starting and ending delineations at each longitudinal end of each of the primary areas, with granules of a given aesthetic in each primary area being spaced apart on longitudinally opposite sides of a given slot.

With reference now to FIG. 6, it will be seen that the completed shingle of FIG. 5, is illustrated in lower or front edge view, and that the completed shingle 40 of FIG. 5 has been provided with either a half height or full height, as may be desired, separate complete layer of shingle material 41, adhesively secured thereto along surface 42, to yield a laminated multi-layer shingle. While FIG. 6 shows a shingle where the separate complete layer of shingle material 41 was applied prior to forming of slots 27, the layer 41 could also be applied after the slots 27 have been formed in the shingle-forming material 10, providing the completed shingle 40 having slots formed in one, but not all, layers of a laminated multi-layer shingle. Alternatively, a single layer shingle could be provided by omitting layer 41 from the shingle construction.

While the embodiments discussed above have three aesthetic areas, A, B, and C, it will be understood that the invention could be applied to a roofing material having a plurality of aesthetic areas. For example, two, three, or four, or more different aesthetic areas may be present on a shingle of the invention.

It will be apparent from the forgoing that various modifications may be made in the details of construction, the manner of manufacture, and the sequence of steps in connection with the manufacture, to yield various aesthetic presentations for a completed shingle, as is embraced within the appended claims.

1. A method of making a shingle having a butt portion and a tab portion with tabs of desired aesthetic in the tab portion being spaced apart by slots, and with adjacent tabs being sharply defined, comprising the steps of:
(a) providing a base web of reinforcing material impregnated with and coated with an adhesive material as a hardenable coating, to an upper surface and a lower surface thereof;
(b) conveying the impregnated reinforcing material in a longitudinal direction;
(c) applying granules of a first aesthetic onto the hardenable coating on the upper surface in first primary areas, each of a first width, in the tab portion of the continuous strip of shingle material, to cover said first primary areas;
(d) applying granules of a second aesthetic onto the hardenable coating of the upper surface in second primary areas, each of a second width, in the tab portion of the continuous strip of shingle material, to cover said second primary areas; and
(e) applying granules of a mixture of those applied to adjacent primary areas, onto the hardenable coating in intermediate areas between said adjacent primary areas, each intermediate area being of an intermediate width; and
(f) cutting generally transverse slots of a predetermined size in said tab portion, so that each said slot is at least as wide in the longitudinal direction as the width of the entire intermediate area in which it is located, to remove said given width of intermediate areas, leaving visually sharp, precise starting and ending delineations at each longitudinal end of each of said primary areas, with granules of a given aesthetic in each primary area being spaced apart on longitudinally opposite sides of a said slot.

2. The method of claim 1, including the step of:
(g) applying granules of third aesthetic onto the hardenable coating of the upper surface in third primary areas, each of a third width, in the tab portion of the continuous strip of shingle material, to cover said third primary areas.

3. A method of making a shingle having a butt portion and a tab portion with tabs of desired shading in the tab portion being spaced apart by slots, and with adjacent tabs being sharply defined, comprising the steps of:
(a) providing a base web of reinforcing material impregnated with and coated with an adhesive material as a hardenable coating, to an upper surface and a lower surface thereof;
(b) conveying the impregnated reinforcing material in a longitudinal direction;
(c) applying granules of a first aesthetic onto the hardenable coating on the upper surface in first primary areas, each of a first width, in the tab portion of the continuous strip of shingle material, to cover said first primary areas;
(d) applying granules of a second aesthetic onto the hardenable coating of the upper surface in second primary areas, each of a second width, in the tab portion of the continuous strip of shingle material, to cover said second primary areas; and
(e) applying granules of a mixture of those applied to adjacent primary areas, onto the hardenable coating in intermediate areas between said adjacent primary areas, each intermediate area being of an intermediate width; and
(f) completely removing said given width intermediate areas.

4. The method of claim 3, including the step of:
(g) applying granules of a third aesthetic onto the hardenable coating of the upper surface in third primary areas, each of a third width, in the tab portion of the continuous strip of shingle material, to cover said third primary areas.

5. A method of making a shingle having a butt portion and a tab portion with tabs of desired shading in the tab portion being spaced apart by slots, and with adjacent tabs being sharply defined, comprising the steps of:
(a) providing a base web of reinforcing material impregnated with and coated with an adhesive material as a hardenable coating, to an upper surface and a lower surface thereof;
(b) conveying the impregnated reinforcing material in a longitudinal direction;
(c) applying granules of a first aesthetic onto the hardenable coating on the upper surface in first primary areas, each of a first width, in the tab portion of the continuous strip of shingle material, to cover said first primary areas;
(d) applying granules of a second aesthetic onto the hardenable coating of the upper surface in second primary areas, each of a second width, in the tab portion of the continuous strip of shingle material, to cover said second primary areas; and
(e) applying granules of a mixture of those applied to adjacent primary areas onto the hardenable coating in intermediate areas between said adjacent primary areas; and
(f) completely removing said intermediate areas.

6. The method of claim 5, including the step of:
(g) applying granules of third aesthetic onto the hardenable coating of the upper surface in third primary areas, each of a third width, in the tab portion of the continuous strip of shingle material, to cover said third primary areas.

7. The method of any one of claims 1, 3 or 5, including the step of cutting the impregnated web with granules into separate shingles of predetermined lengths.

8. The method of claim 7, including the step of applying a second layer of impregnated reinforcing material with granules thereon to the base web of impregnated reinforcing material with granules thereon, to make a laminated shingle.

9. The method of claim 8, wherein the second layer of impregnated reinforcing material with granules thereon is applied after said intermediate areas are removed.

10. The method of claim 8, wherein the second layer of impregnated reinforcing material with granules thereon is applied before said intermediate areas are removed.

11. The method of claim 7, wherein said tabs of desired aesthetic have a varied parameter from one tab to another, said varied parameter being selected from the group of tab shape, tab length, tab width and slot width.

12. A shingle made according to the method of claim 7.

13. A shingle made according to the method of claim 8.

14. The method of claim 7, wherein granules of different aesthetics are applied from different granule applicators, wherein the steps of cutting the transverse slots, completely removing the intermediate areas or completely removing the given widths of intermediate areas removes all zones or areas on each tab portion where there is a blend of granules from different granule applicators, and wherein the granules of the different aesthetics can be any one of:
(a) granules of different shades;
(b) granules of different shades of the same color;
(c) granules of different colors;
(d) granules of different appearances;
(e) granules of different sizes;
(f) granules of different shapes;
(g) granules of different textures; and
(h) granules of any one or more of natural rock, slag, ceramic coated rock, mineral particles, or granules of various mineral content.
